(19) United States
(12) Patent Application Publication
(10) Pub. No.: US 2017/0330338 A1
(43) Pub. Date: Nov. 16, 2017

(54) METHOD FOR DETECTING STRIATIONS IN A TIRE

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: ALEXANDRE JOLY, Clermont-Ferrand (FR); RÉGIS VINCIGUERRA, Clermont-Ferrand (FR); ALEXANDRE CHARIOT, Clermont-Ferrand (FR)

(21) Appl. No.: 15/534,177

(22) PCT Filed: Dec. 16, 2015
(86) PCT No.: PCT/FR2015/053538

§ 371 Date: Jun. 8, 2017

(30) Foreign Application Priority Data
Dec. 19, 2014 (FR) 1462898
Dec. 19, 2014 (FR) 1462901

(51) Int. Cl. G06T 7/40; G06F 17/30; G06T 7/00; G06T 7/90

(52) U.S. Cl. CPC G06T 7/40; G06T 7/0008; G06F 17/3025; G06F 17/30256; G06T 7/001; G06T 7/90; G06F 17/3028; G06T 2207/10024; G06T 2207/20021; G06T 2207/20224

(57) ABSTRACT

In this method for referencing striations present in digital representations (10) of tires, automated means execute the following steps in order to reference types of striation:
determining at least one representation comprising a type of striation (1, 2) to be referenced,
identifying at least one segment of pixels or voxels of the representation (10), and
recording at least one value relating to differences between grey levels or colour levels of pixels or voxels of the segment.

The invention relates to the detection and referencing of striations in images.

It is desirable to detect striations, notably in images of tires, for the purpose of locating the areas of tires where information is engraved. It may also be desirable to locate these areas in order to check subsequently that they contain no defects. A striated area is such that it has a pattern, such as a shape, line or curve, which is regularly repeated in a given direction.

There are known methods for detecting striations in images in which a spectral approach is used to detect striation frequencies. Fourier filtering is generally used for this purpose. A Fourier transform is performed on the image to be examined. In the resulting image, representing the frequencies of the examined image in the Fourier space, peaks are found, corresponding to different frequencies of grey levels or colour levels of the image. Thus frequencies corresponding to striations in the initial image are found, and the presence and location of the striations in the initial image are deduced from these frequencies. However, this approach is costly in calculation time, notably when used on large images for which the Fourier transform has to be calculated. It is also rather difficult and imprecise, notably because it is a complicated matter to separate the frequencies corresponding to striations from the frequencies corresponding to background noise. This is because the frequency peaks corresponding to striations are rarely delimited clearly in the image obtained by the Fourier transform.

Another type of method for detecting striations in an image consists in comparing the examined image with what are known as reference images comprising striations, and calculating a correlation rate between the images. The main drawback of this type of method is that it requires a very large amount of memory to contain the reference images and a very long calculation time to compare the image portions with each other and determine a correlation rate.

One object of the invention is to provide a method which is less costly in calculation time and memory, while being simpler, more precise and more reliable than the aforementioned methods.

For this purpose, a method is provided for referencing striations present in digital representations of tires, in which automated means execute the following steps in order to reference types of striation:
determining at least one representation comprising a type of striation to be referenced,
identifying at least one segment of pixels or voxels of the representation, and
recording at least one value relating to differences between grey levels or colour levels of pixels or voxels of the segment.

Thus the recorded value, or each of the recorded values, is used subsequently as a control with which one or more values measured in an examined image are compared, in order to determine whether or not the examined image comprises striations. The segment approach may be used to reference values relating to a sequence of successive pixels, instead of studying the image one pixel at a time, for example. This approach is therefore particularly suitable when the segment is perpendicular to striations, the values relating to differences between the grey levels or colour levels then revealing the variation of levels of the pixels. This method is independent of the type of striation detection method used subsequently. The same comments are applicable where voxels, rather than pixels, are concerned. This is also true throughout the following text when pixels are considered.

The digital representations on which a method according to the invention is used may be of three types:
Representations known as “2D”, corresponding to two-dimensional images in which each pixel carries luminance information,
Representations known as “2.5D”, corresponding to two-dimensional images in which each pixel carries depth information,
Representations known as “3D”, corresponding to three-dimensional images in which each voxel carries luminance information.

If the acquisitions used contain a data element of the “relief” type, each pixel of the image carries topographic information on the depth of the striations. The grey level or colour level corresponds to this striation depth. If the acquisitions carry luminance information, the level corresponds, for example, to the contrast between the bottoms and the tops of the striations.

Advantageously, the value or at least one of the values is selected from among the following group:
a mean period of the periods relating to pixels or voxels of the segment,
a mean of absolute values of differences between grey levels or colour levels within each pair of adjacent pixels or voxels of the segment, and
preferably, additionally, a length determined on the basis of the mean period.

Thus the mean acts as a control for determining whether or not a segment of pixels of an examined image is located in a potentially striated area. As the number of striations increases, the number of different grey level pixels next to each other also increases, as does the mean difference of levels between adjacent pixels. The mean period may be used to establish a mean interval of distance between the peaks of the striations or between the inter-striation troughs. Finally, the length may be used to compare segments which are large enough to contain relevant information on the area of striations and small enough to prevent the calculation of the reference value, or other reference values, from being too time-consuming. The length of the segment is advantageously set at 3.5 mean periods. The combination of these three parameters, namely the period, the mean, and the length, may be used to reference types of striation. In any area of striations, there may be numerous fine striations, a small number of large striations, or other types. Each type of striation therefore corresponds to a value or a combination of values of the three reference parameters. A method for checking a tire is also provided, in which method, in order to locate an area of striations in a digital representation of a tire, automated means execute the following steps:
considering at least one pixel or voxel of an area of the representation, and, for the pixel or voxel considered, or for each pixel or voxel considered:
identifying a segment of pixels or voxels centred on the pixel or voxel considered,
determining at least one value relating to differences between grey levels or colour levels of pixels or voxels of the segment, and
comparing the value or values with one or more predetermined thresholds.

Thus, here again, the segment approach may be used to determine values relating to a sequence of successive pixels, instead of studying the image one pixel at a time. This approach is therefore particularly suitable when the segment to be examined is perpendicular to striations, the values relating to differences between the grey levels or colour levels then revealing the variation of levels of the pixels. Furthermore, it is no longer necessary to attempt to detect frequency peaks in an image transformed by complex calculations, such as a Fourier analysis, since the image to be examined is used directly for the purpose of detecting the striations. Furthermore, when moving from one considered pixel to an adjacent considered pixel, the segment centred on this pixel comprises values relating to differences of levels of pixels or voxels that have already been calculated. Thus it is possible to calculate values relating to differences among a plurality of overlapping segments rapidly, by factoring the calculations.

Advantageously, the value or at least one of the values relating to the differences is a mean of absolute values of differences of levels within each pair of adjacent pixels or voxels of the segment.

Thus, the mean of the absolute values of the differences may be used to determine whether or not the segment is located in a highly striated area. This value can be determined simply and quickly, and in this way the pixels not forming part of a striated area can be eliminated. For example, if the mean difference is small, this signifies that the segment, and therefore the pixel located at its centre, is located in area that is rather homogeneous in terms of grey levels or colour levels. On the other hand, if the mean difference is high, this means that the grey levels or colour levels vary considerably across the segment, from a pixel located at one end to the pixel located at the other end. In this case, it is considered that the pixel located at the centre of this segment may be in an area of striations, and it is not eliminated.

Preferably, the value, or at least one of the values, relating to the differences is a mean period of periods relating to the pixels or voxels of the segment.

Thus, the mean period represents the mean distance between two identical changes of values of adjacent pixels within the segment. This therefore corresponds to the mean interval between two peaks of striations of the segment, or between two inter-striation troughs.

Advantageously, the value or at least one of the values relating to the differences is a number of periods relating to pixels or voxels of the segment.

Preferably, the value or at least one of the values relating to the differences is one or more periods relating to pixels or voxels of the segment.

Thus, it is possible, for example, to compare each period, for example an interval between two striation peaks, with a predetermined value.

Advantageously, the automated means associate a binary value “0” or “1” with each pixel or voxel of the segment on the basis of its level, and the value or at least one of the values relating to the differences relates to changes between values within pairs of adjacent pixels or voxels when the automated means scan the segment in one direction, these changes being identical and the first pixel of each pair preferably comprising a value identical to that of a pixel or voxel of the segment located at an end of the segment which is predetermined according to the direction.

Thus the segment is binarized so that only two types of pixels are distinguished, namely those located in a striation and those located between two striations. All the calculations of values relating to differences between grey levels or colour levels of pixels or voxels of the segment, and notably the calculations of periods, are then simplified.

Moreover, when the calculation of values relating to the pixels or voxels is made to depend on the binary value of the first pixel or voxel of the segment, the calculation of a value relating to the differences in levels is performed only on an interval between two striation peaks, or on an interval between two inter-striation troughs, but not on both of these at the same time. In this way, the calculation time is reduced further.

Advantageously, in order to associate a binary value with a pixel of the segment,
a mean value of the values of the pixels or voxels of the segment is determined;
a binary value is assigned to each pixel or voxel of the segment as a function of la difference between its value and the mean numeric value.

Thus, for example, if the value of the pixel or voxel is greater than or equal to the mean value, it is associated with the binary value “1”; otherwise it is associated with “0”.

Preferably, the automated means associate a binary value “0” or “1” with each pixel or voxel of the segment on the basis of its level, and the value or at least one of the values relating to the differences relates to changes between values within pairs of adjacent pixels or voxels when the automated means scan the segment in one direction, these changes being identical, and the first pixel of each pair preferably comprising a value which is preferably different from that of a pixel or voxel of the segment located at an end of the segment which is predetermined according to the direction.

Thus, the secondary periods represent either an interval between two inter-striation troughs or an interval between two striation peaks, but not both, in the same way as the values defined above and in a complementary manner to them. Thus, if the values defined above relate to an interval between two striation peaks, the secondary periods relate to the intervals between inter-striation troughs, and vice versa.

Advantageously, the segment is composed of at least three consecutive pixels or voxels of the representation.

A method for checking the conformity of tires is also provided, in which automated means execute the following steps:
determining at least one dilation of a base representation comprising at least one area of striations of a tire, so as to obtain a dilated representation;
determining at least one erosion of the base representation so as to obtain an eroded representation; and
determining a difference between the dilated representation and the eroded representation so as to obtain a difference representation.

The dilation creates a smooth area of striations in the dilated image, in place of the area of striations of the base image, the intervals between the striations having been erased by the dilation. The erosion, on the other hand, creates a smooth area of striation intervals in the eroded image, in place of the area of striations of the base image, the striations having been erased by the erosion. Thus, if the striations of the base representation are perfect, the difference representation must comprise a perfectly homogeneous area in the same position as the area of striations in the base representation. In practice, if the area of striations contains no defect, the difference representation comprises an area corresponding to the area of striations, in which the grey levels or colour levels are substantially constant, within an interval of noise tolerance. In the contrary case, the difference representation comprises one or more areas in which the grey levels or colour levels are very different from those of the surrounding pixels.

Provision is also made for a computer program comprising coded instructions adapted to command the execution of the steps of the method according to the invention when it is executed on a computer.

Finally, according to the invention a device is provided for checking striations in representations of tires, this device being adapted to execute a method as described above.

According to another aspect of the invention, one object is to provide a method for analysing the conformity of striations of tires which is less costly in calculation time and faster to execute.

For this purpose, a method for checking the conformity of tires is provided, in which automated means execute the following steps:
determining at least one dilation of a base representation comprising at least one area of striations of a tire, so as to obtain a dilated representation;
determining at least one erosion of the base representation so as to obtain an eroded representation; and
determining a difference between the dilated representation and the eroded representation so as to obtain a difference representation.

Such a method does not require the use of a reference, giving it the advantage of being simpler to execute than the known methods. Preferably, the automated means create one or more structuring elements of the dilation and erosion on the basis of a dimension of the striations, an interval between the striations, and/or an orientation of the striations.

Thus the structuring elements are adapted to each type of striation detected upstream. In this way the most appropriate dilation and erosion operations possible can be performed, thus erasing the striations and the intervals between striations, respectively, in the most correct way possible, while retaining the other elements.

Advantageously, the automated means cause at least two dilations of the base representation with different respective structuring elements, to obtain the dilated representation.

Preferably, the automated means cause at least two erosions of the base representation with different respective structuring elements, to obtain the eroded representation.

Thus, for complex shapes such as striations having more than one orientation or different thicknesses within the same area of striations, the striations are separated into different types of striation, and the dilation and/or erosion operations are repeated for each type of striation, with structuring elements adapted to the different types of striation in the area.

Advantageously, numeric values of pixels or voxels of the difference representation are compared with at least one predetermined threshold.

Thus, if some of the values of the pixels or voxels are distant from the threshold, it is considered that the striations of the base representation contain a defect. On the other hand, if all the values lie within a predetermined interval relative to the predetermined threshold, it is considered that the area of striations of the base representation contains no defect, and that the tire is therefore in conformity.

Preferably, the threshold or at least one of the thresholds is a median of values of the pixels or voxels of the difference representation.

Advantageously, the base representation comprises no colour other than black, white and grey levels.

However, the base representation may also comprise black, white and grey.

Preferably, in order to locate an area of striations in a digital representation of a tire, automated means execute the following preliminary steps:
considering at least one pixel or voxel of an area of the representation, and for the pixel or voxel considered, or for each pixel or voxel considered:
identifying a segment of pixels or voxels centred on the pixel or voxel considered,
determining at least one value relating to differences between grey levels or colour levels of pixels or voxels of the segment, and
comparing the value or values with one or more predetermined thresholds.

Thus the segment approach may be used to determine values relating to a sequence of successive pixels, instead of studying the image one pixel at a time. This approach is therefore particularly suitable when the segment to be examined is perpendicular to striations, the values relating to differences between the grey levels or colour levels then revealing the variation of levels of the pixels. Furthermore, it is no longer necessary to attempt to detect frequency peaks in an image transformed by complex calculations, such as a Fourier analysis, since the image to be examined is used directly for the purpose of detecting the striations. Moreover, when moving from one considered pixel to an adjacent considered pixel, the segment centred on this pixel comprises values relating to differences of levels of pixels or voxels that have already been calculated. Thus it is possible to calculate values relating to differences among a plurality of overlapping segments rapidly, by factoring the calculations.

A method is also provided for referencing striations present in digital representations of tires, in which method automated means execute the following steps in order to reference types of striation:
determining at least one representation comprising a type of striation to be referenced,
identifying at least one segment of pixels or voxels of the representation, and
recording at least one value relating to differences between grey levels or colour levels of pixels or voxels of the segment.

Thus, the recorded value, or each recorded value, is subsequently used as a control with which one or more values measured in an examined image are compared, in order to determine whether or not the examined image contains striations. The segment approach may be used to reference values relating to a sequence of successive pixels, instead of studying the image one pixel at a time, for example. This approach is therefore particularly suitable when the segment is perpendicular to striations, the values relating to differences between the grey levels or colour levels then revealing the variation of levels of the pixels. This method is independent of the type of striation detection method used subsequently.

Provision is also made for a computer program comprising coded instructions adapted to command the execution of the steps of the conformity checking method according to the invention when it is executed on a computer.

A device for checking the conformity of tires is also provided, this device being adapted to execute one of the methods described above.

Finally, a computer-readable storage medium is provided, this medium comprising a program according to the invention in recorded form.

Preferably, the device comprises a recording medium comprising a database of values relating to striations.

An embodiment of the invention will now be described by way of non-limiting example, with the aid of the attached drawings, in which:

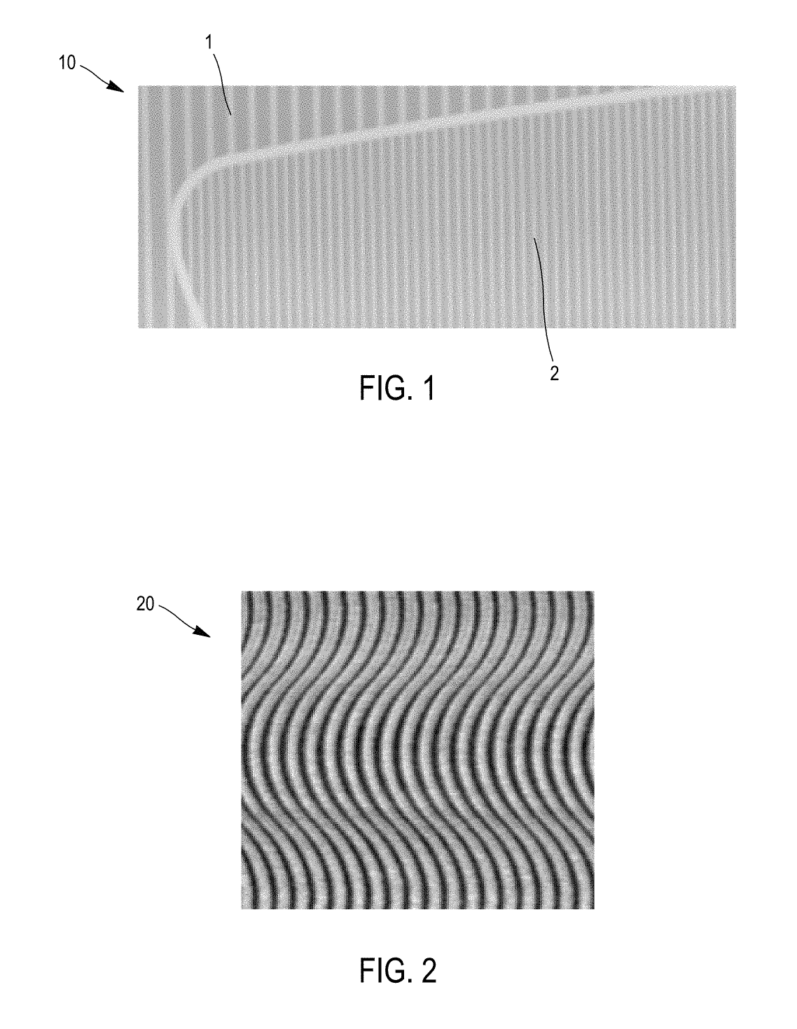

FIGS. 1 and 2 show digital images containing areas of striations;

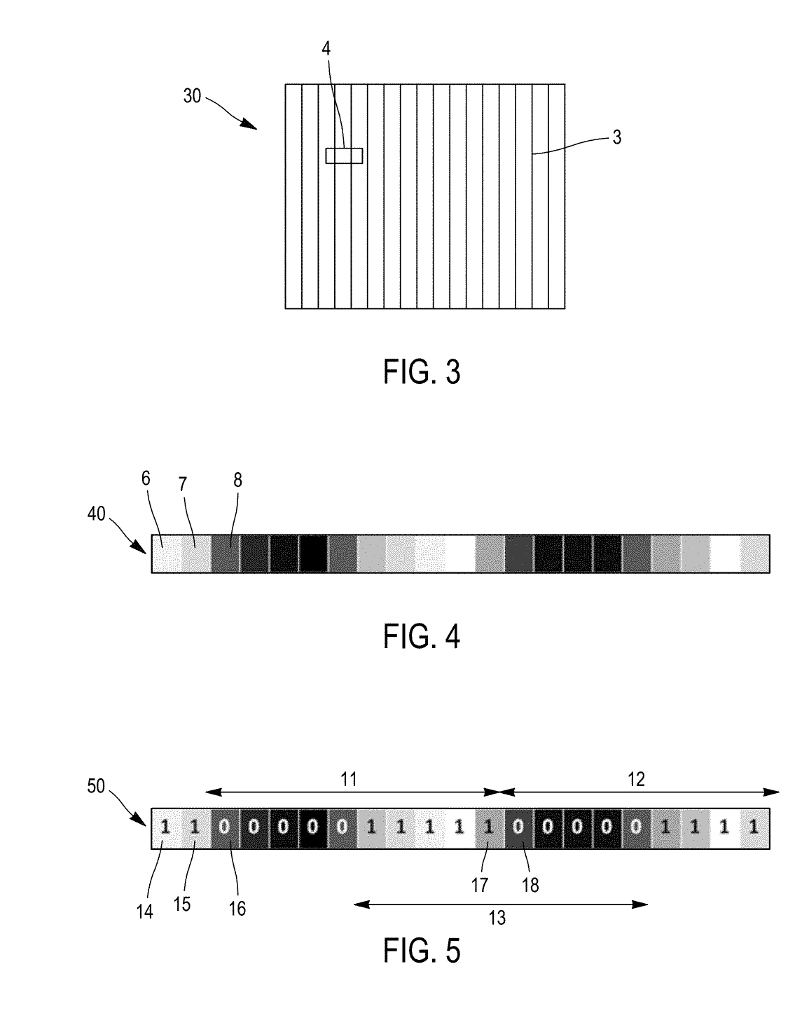

FIGS. 3 to 5 show schematically, respectively, a digital image, a segment of this image, and the segment in binarized form;

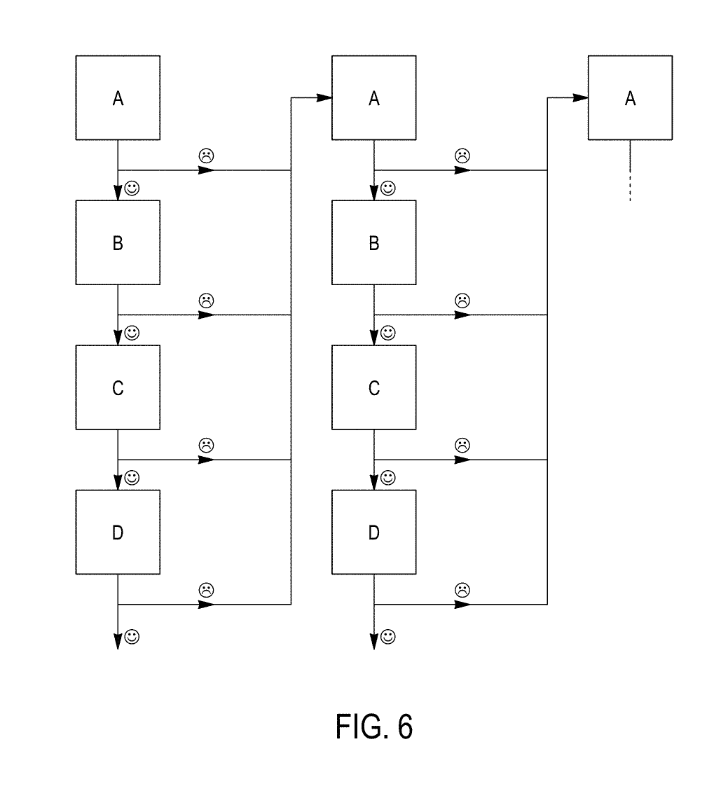

FIG. 6 shows a method according to an embodiment of the invention;

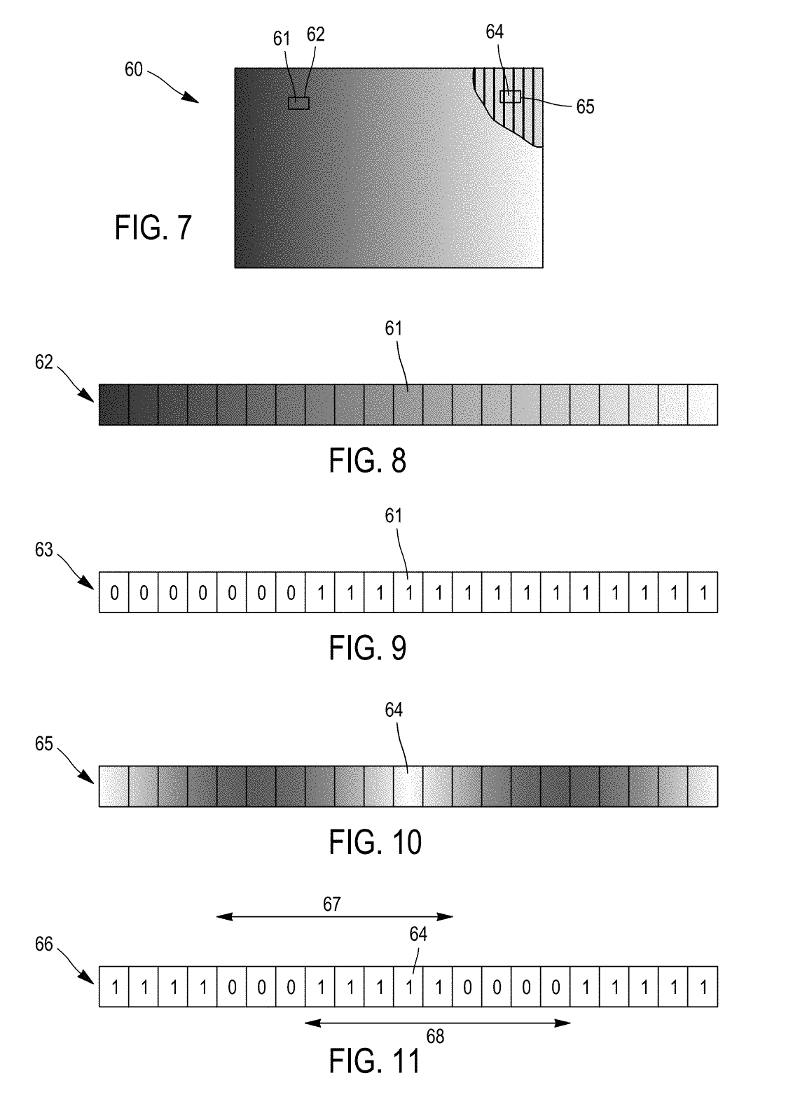

FIGS. 7 to 11 show schematically, respectively, an image, a segment of the image, the segment in binarized form, another segment of the image, and this segment in binarized form;

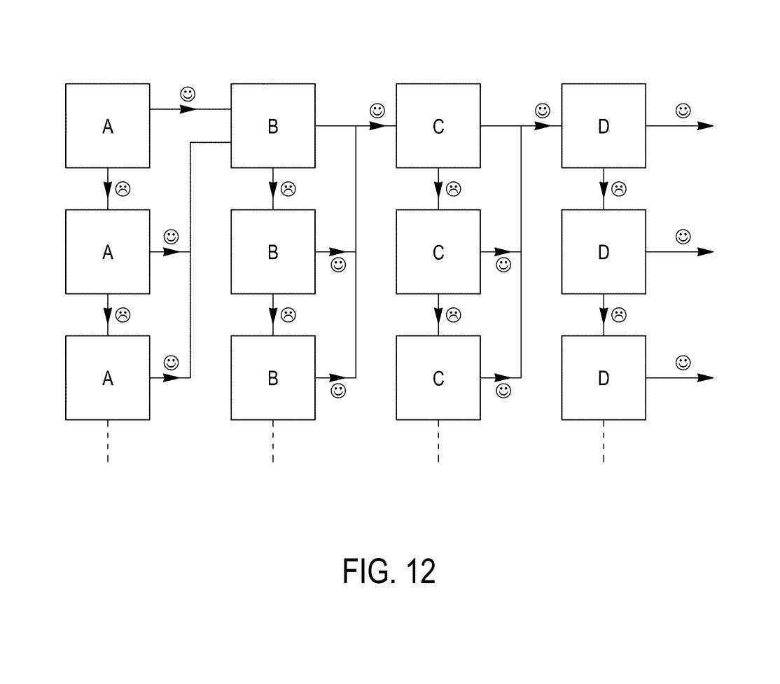

FIG. 12 shows a method according to another embodiment of the invention;

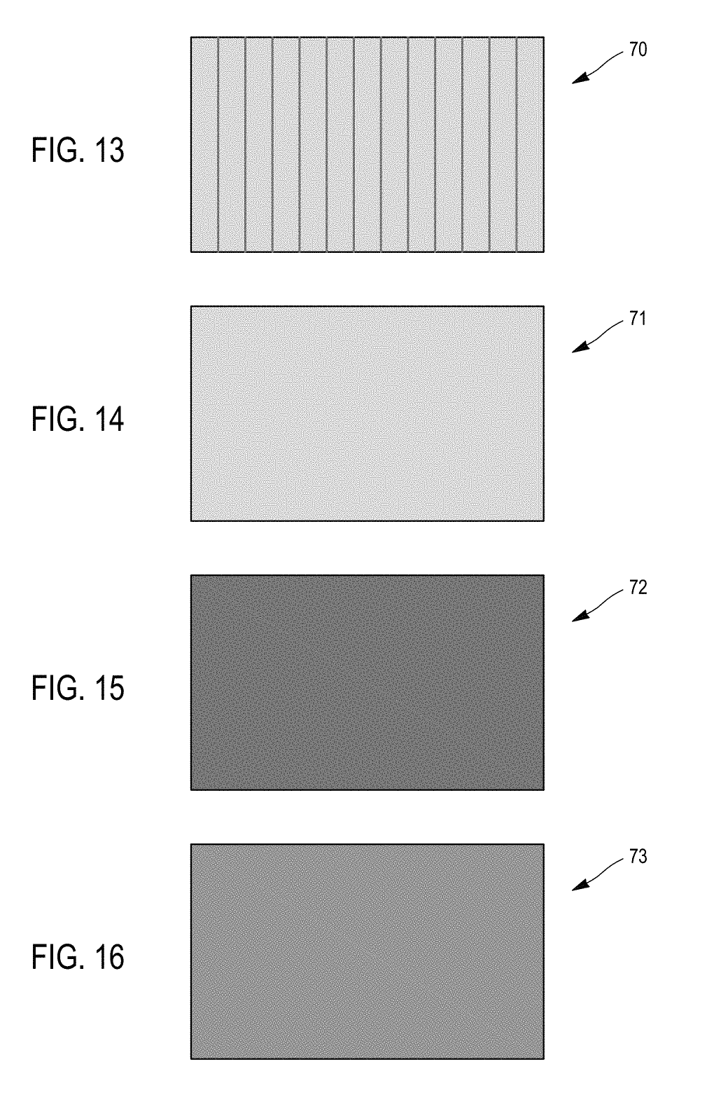

FIGS. 13 to 16 show schematically a digital image, the image in eroded form, the image in dilated form, and a difference image between the dilated and eroded images;

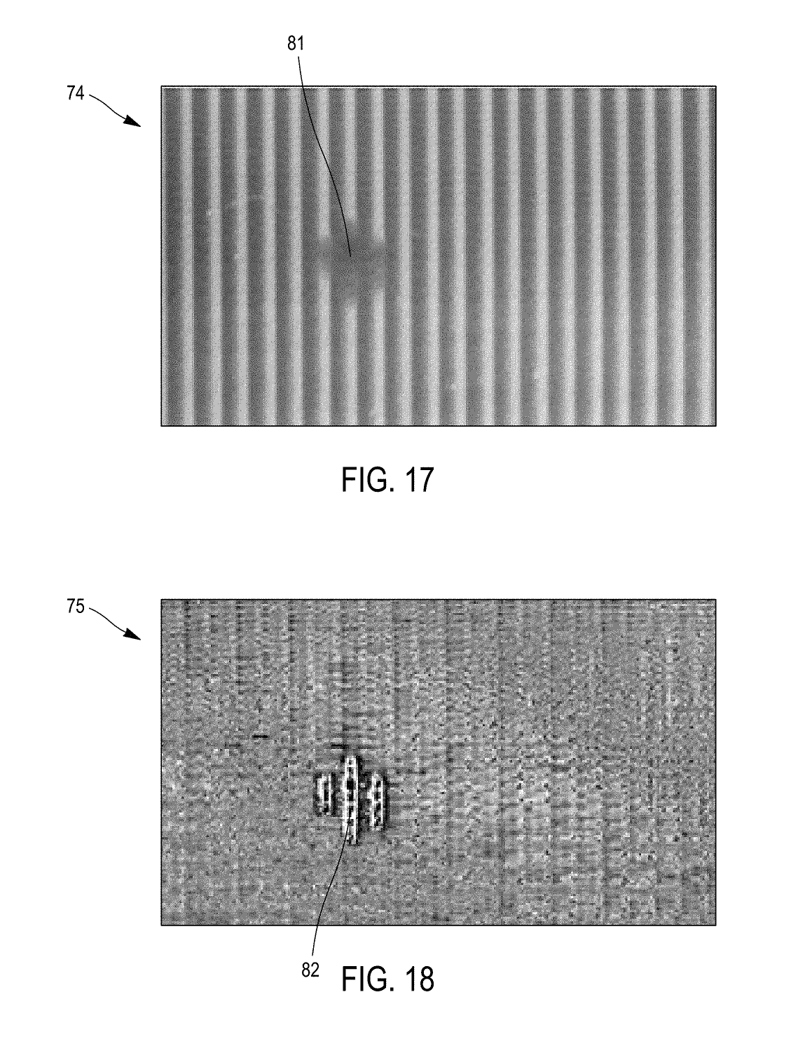

FIGS. 17 and 18 show, respectively, a digital image comprising an area of striations having a defect and the difference image resulting from this image in an embodiment of the invention, and

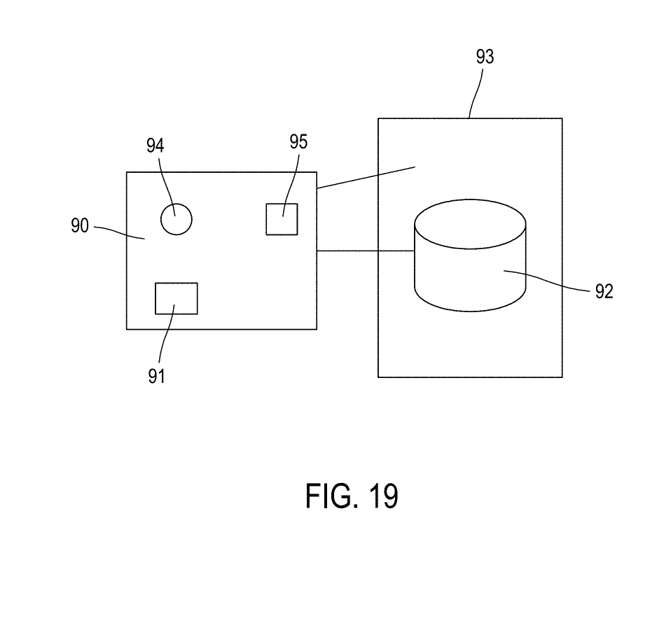

FIG. 19 shows a device for executing a method according to the invention.

The tire checking method is intended to create a tire image base in order to reference types of striation, and then to detect striations similar to the types of striation referenced in test images. The method for checking the conformity of striations is intended to check whether areas of striation of tires have defects.

### I Referencing Method

The method consists in referencing types of striation initially, then detecting striations in images by using the referenced striations.

FIGS. 1 and 2 show different types of striation in two-dimensional images 10 and 20. These types of striation differ from each other in the thickness of the striations, their orientation, their straightness, and the interval between the striations, as well as the grey levels of the striations and the intervals of striations of each type. FIG. 1 also shows two areas 1 and 2 of different types of striation. The aim is to reference all these types of striation initially, and then to detect them when these striations are found in an image.

The steps of the various embodiments to be described are executed by automated means 91 forming part of a device 90, which comprises, notably, a processor 94 and a memory 95, and which is connected to a database 92. These elements are illustrated in FIG. 19. In order to execute the method, the device uses a computer program. This program may request at its input an image or a set of images comprising areas of striation to be referenced, together with an image or images to be examined. At its output, it supplies the user with the data on each reference type of striation, together with the types of striation determined and their location in the images to be examined. The same program, or a separate program, may also be used to apply a conformity checking method as described below. It then requests an image comprising an area of striations at its input, and supplies an image called a “difference image” at its output, together with data concerning pixels representing any defects. The input image may be supplied automatically by the method itself when it has detected striations in an image. Thus the same program may be used to determine striations in an image of a tire, and at the same time to determine whether or not these striations have defects.

This program may also be made available on a telecommunications network, such as the Web, or an internal network, to enable a user to download it.

Similarly, the program or equivalent instructions may be recorded on a computer-readble storage medium 93, such as a hard disc, a USB flash drive, a CD, or any other equivalent medium, which may include the database.

To perform the referencing of types of striation, images called “reference images” are selected, these images comprising areas of striation such as the images 10 and 20 of FIGS. 1 and 2, to construct a reference base. As the number of reference images in the base increases, the number of different types of striation that are referenced also increases, together with the number of different types of striation that can be detected in tire study or test images. This reference base may comprise any image comprising a striated area, even if this is not explicitly described in the present application. In the present case, the schematic image 30 of FIG. 3, comprising vertical striations 3, will be considered. In the area of striations, a segment 4 of pixels is selected. This is called the “reference segment”. Each pixel of the image 30, and therefore each pixel of the reference segment 4, has a grey level value. Specifically, a reference segment 4 of 21 pixels is selected. A reference segment comprising a different number of pixels could have been selected. This number corresponds to a reference segment which is large enough to intercept a plurality of striations and small enough to prevent the calculations described below from being too time-consuming. When the reference segment 4 has been selected, the following steps are executed:

1) the differences in grey level, as absolute values, between each pair of adjacent pixels of the reference segment 4 are calculated. Thus, in the segment 4 of FIG. 4, which shows on a large scale and in a schematic manner the reference segment 4 of FIG. 3, the difference as an absolute value between the grey level of pixel 6 and the grey level of pixel 7 is determined, then the difference between pixel 7 and pixel 8, and so on.

2) These differences are added together and divided by the number of pixels in the reference segment minus one unit; that is to say, in the present case, the division is by 20, so as to obtain the mean of the differences in grey levels between each pair of adjacent pixels in the segment. This mean, called the “reference mean”, is recorded in a database.

3) A mean of the grey levels of the pixels of the reference segment is calculated.

4) Within the reference segment, the values of pixels are binarized on the basis of the mean of the grey levels calculated previously. Thus, if a grey value of a pixel equals or exceeds the mean of the grey levels of the reference segment, the corresponding pixel is given the value “0”. If a grey value is below the mean, the corresponding pixel is given the value “1”. This results in a segment 50, shown in FIG. 5. On the basis of this segment 50, the following calculations are performed:

5) distances called the main periods are determined from the segment 50 of binarized pixels. A main period corresponds to the shortest distance, in numbers of pixels, between two changes between values within pairs of adjacent pixels when the segment is scanned from left to right, these changes being identical, and the first pixel of each pair having a value identical to that of the first pixel of the segment located at the left end. Thus, in FIG. 5, the first pixel 14 located at the left end has the binary value “1”. A search is therefore made for the first change between a pixel with a binary value of “1” and a pixel with a binary value of “0”. This change takes place between pixels 15 and 16. A search is then made for the second identical change, that is to say between a pixel with a binary value of “1” and a pixel with a binary value of “0”, scanning the segment from left to right. This change takes place between pixels 17 and 18. In this way the main period 11, composed of eleven pixels, is obtained. Continuing in the same way, the one or more subsequent main periods 12 are found in the segment. It would be possible to perform the same type of calculation by scanning the segment from right to left. The first pixel of the segment whose binary value would be observed would then be the first pixel at the right-hand end of the segment.

6) The mean period of the main periods of the segment is then calculated, and is recorded in the database. This will subsequently be called the “mean reference period”.

7) The “reference length” of a segment is set. In the present case, it is set at 3.5 times the mean reference period. A number other than 3.5 could be chosen, with the proviso that this number must always be greater than 1.

As a result of the aforesaid steps, the type of striation of FIG. 3 has now been entered as a reference in the database. The three data elements entered for this type of striation, namely the reference mean, the mean reference period and the reference length, must enable this type of striation to be detected in any image to be examined, if these striations are present.

II The Method for Detecting Striations

We shall now examine the detection of striations in an image, that is to say the method for detecting and locating striations in a given image, by comparing them with the striations referenced by the three data elements recorded for each type of striation, as explained above. If a large number of types of striation have been referenced, each referenced type of striation may be compared with the values that will be determined during the detection. For this purpose, with reference to FIG. 6, which shows a method according to a preferred embodiment of the invention, the following steps are executed for a given type of striation:

A) In an image to be examined, in this case the image 60 of FIG. 7, a pixel 61 is selected. An examination segment 62 of 21 pixels is determined, centred on the pixel 61. This segment is illustrated in detail in FIG. 8. In the same way as in steps 1) and 2) of the referencing method, the mean of the absolute values of the differences in levels within each pair of pixels of the examination segment 62 is determined. The result is then compared with a “reference mean” of a type of striation recorded by the referencing method, the aim being to compare the image to be examined with this type of striation. For this purpose, the mean calculated for the examination segment 62 of the image 60 is compared with an interval of predetermined values centred on the “reference mean” of the type of striation considered. If the mean calculated for the examination segment is located in the interval, the segment is subjected to step B). If the result does not lie within the interval, another type of referenced striation, to which the examination segment 62 is to be compared, is selected, and the method restarts at step A) for the new referenced type of striation considered. This is equivalent to using a high threshold and a low threshold on either side of the reference mean and comparing the result with these thresholds.

If the result does not lie within any interval of values for all the referenced types of striation, this means that the pixel 61 does not belong to any type of referenced striation. All testing for the pixel 61 is halted, and the process may be recommenced with another pixel.

This criterion eliminates the great majority of bad pixels, leaving only the pixels in areas having a minimum of texturing, but not necessarily resembling striations.

B) The segment is binarized in the same way as in step 4) of the referencing method, and the same calculations as in steps 5) and 6) are performed. This results in a mean period of the main periods in the examination segment 62, represented schematically by the binarized examination segment 63 of FIG. 9. This mean period is then compared with the reference period recorded for the type of striation that was successfully considered in step A). In the same way as before, this comparison is carried out for an interval of values centred on a “mean reference period”. If the mean period of the segment 63 belongs to the interval of values, then the pixel 61 and its binarized examination segment 63 go to step C); otherwise, another type of striation is selected, and the method is resumed at step A), for the new type of striation concerned.

This criterion eliminates the areas that have no resemblance at all to the type of striations searched for, that is to say to the types of striations referenced.

C) The number of main periods of the binarized examination segment 63 is compared with the recorded “reference length” corresponding to the type of striation considered, with an interval of values centred on the value of the reference length, in the same way as in the preceding steps.

This criterion mainly eliminates some bad areas near the margins of the texts, but also the lateral margins of areas of striations that might have been recognized and located. These areas may be retrieved subsequently by means of binary morphology steps such as dilations or erosions.

If the examination segment passes this step, the method moves to step D). Otherwise, step A) is repeated with a new reference type of striation.

D) All the periods of the binarized examination segment 63 are compared with the reference period of the reference segment, still for the same type of striation as in the preceding steps. For this purpose, the method takes into account not only the main periods, but also secondary periods which correspond to the changes between values within pairs of adjacent pixels when the test segment is scanned in one direction, these changes being identical and the first pixel of each pair comprising a value which is preferably identical to that of a pixel or voxel of the segment located at an end of the test segment which is predetermined according to the direction. An example of a secondary period for a segment is the period 13 of the segment 50 of FIG. 5. Thus, each of these periods is compared with an interval of predetermined values centred on the mean reference period of the type of striation considered.

If all the main and secondary periods lie within the interval, then the pixel 61 on which the examination segment 62 is centred is considered to belong to the type of striation for which steps A) to D) have been executed.

Otherwise, the process is restarted from step A) with a new reference type of striation.

If all the reference types of striation have been compared to the segment and the pixel still fails to pass step D), it is considered that the pixel 61 of the examination segment 62 does not belong to the types of striation that have been referenced, and the process is stopped. It may be restarted from step A) with another pixel on which another examination segment will be centred.

In the present case, it is highly likely that pixel 61 of the segment 62 will not pass step B), or may even be eliminated in step A), in view of the grey levels of the examination segment, if this segment is compared solely with a referenced type of striation similar to that of FIG. 3. Furthermore, this segment has no main period or secondary period.

However, if the method is restarted with pixel 64 of FIG. 7, and the examination segment 65 centred around the pixel 64 is selected, this pixel will probably successfully pass the method up to step D) if it is compared with a referenced type of striation similar to that of FIG. 3, in view of the grey levels and binary values of the examination segment 65 shown in detail in FIG. 10 and of the binarized examination segment 66 of FIG. 11. A main period 67 and a secondary period 68 are also determined. This pixel 64 is then considered to form part of an area of striations similar to an area of striations of the type shown in FIG. 3 to which it has been compared.

Similarly, as soon as a pixel has successfully passed step D), the process is restarted with another pixel, for the same referenced striation type.

In one embodiment, the method stops when all the pixels of the image have been considered, that is to say when all these pixels have undergone at least step A) of the method.

In another embodiment, only a certain portion of the image, or certain pixels of the image, are selected, and the method is only applied to these pixels.

For example, a user may have visually located an area that may contain striations in an image, and may decide to apply the method to this area of the image only.

In a variant, in step A), certain differences between pixels are recorded. This is because, if calculations are initially performed for a given pixel, followed by calculations for a pixel located on the same pixel line of the image, their examination segments may comprise identical pixels. It is then helpful to re-use the previously calculated results in the calculation.

It should be noted that step A) is independent of the other three steps, because the segments do not have to be binarized in order to perform this step. In fact, this step is the simplest of all, which is why it is performed first.

In another embodiment illustrated by the diagram of FIG. 12, when a pixel is not admitted to a step other than step A), then, instead of restarting the process at step A) with another type of striation, the test of the same step is carried out with another type of striation. Thus a pixel may pass the test of step A) for a given type of striation, then pass step B) for another type of striation, and so on.

In another embodiment, the intervals of value used for comparison are also recorded in the database. They are not necessarily centred on reference values such as the mean reference period, the reference length or the reference mean. They may comprise these values without being centred on them. Thus certain variations are tolerated with respect to the reference values in one direction, but not in another.

In another embodiment, the aim is to detect only one type of striation or a plurality of specific types of striation in the examination segments. This consists in comparing the data of the examination segment with the referenced data relating to these types of striation and not to the other referenced types of striation.

III Method for Checking the Conformity of the Striations

When the striations have been located on an image of a tire, the conformity of these striations is examined. The aim is to verify that the areas comprising striations have no defect that might adversely affect the understanding of the symbols expressed by these striations. This is known as a visual conformity check. It is necessary for the striations to have been located in advance, for two reasons: the usual conformity checks for other areas cannot be applied to areas of striations, and the criteria for the measurement and tolerance of defects in these areas of striations may be different from those of other areas.

In a flat area, a defect is characterized by an elevation which is greater or smaller than the mean for the area.

In an area of striations, the principle of the method in the present embodiment is that of filtering the striations in two different ways so as to obtain two images of flat areas, namely an image representing a mean of the bottoms of the striations and an image representing a mean of the peaks of the striations. An image resulting from the difference between the two aforesaid images, which should contain pixels of a relatively constant value in the area of striations, is then examined. The defects are then visible when portions of the areas which are normally constant have “abnormal” values.

In the present case, the aim is to know whether the striations of the image 70 of FIG. 13 have defects.

For this purpose, an erosion of the image 70 is carried out, to obtain an eroded image. The structuring element is selected in such a way that the striations disappear in the eroded image. Thus the interval between the striations, the orientation of the striations, and their size are taken into account for the purpose of selecting the structuring element. Since erosion takes place in grey levels, it is also possible to take the grey levels of the striations and the intervals into account. The eroded image 71 of FIG. 14 therefore represents a mean of the bottoms of the striations, in other words a mean of the troughs between the striations.

A dilation of the image 70 is also carried out. The element selected as the structuring element of the dilation is one that enables the striations to be dilated so that they fill the intervals between the striations, on the dilated image 72 of FIG. 15. The criteria for the selection of the structuring element for the dilation are the same as those for erosion. The dilated image 72 thus represents a mean of the peaks of the striations.

The difference between the dilated image 72 and the eroded image 71 is then found, in order to obtain a difference image 73. In this case, the latter image has a homogeneous content. Consequently there is no defect in the area of striations of the image 70.

However, if the same method is executed with the image 74, which has a small defect 81 in which portions of striations are erased, the result is a difference image 75 which reveals this defect, in the form of a portion 82 in which the grey levels are abnormal with respect to a relatively homogeneous area around said defect.

The method according to the invention may be used to detect these defects automatically, by comparing the value of the grey levels of the pixels with the median value of the pixels of the difference image. Thus, if the value of one of the pixels of the difference image is too distant from the median value of the pixels of the image, the pixel in question is considered to be manifesting a defect in the area of striations of the image.

In another embodiment of the invention, a plurality of dilations and/or erosions may be performed. For example, if an area of striations comprises striations orientated in different directions, or comprising different thicknesses, it is possible to identify a type of striation, perform the operations for this type of striation, and the re-apply the method for another type of striation identified in the area. Thus, in certain cases, the defects of one type of striation and the defects of another type of striation are found, in an area where these striations are additional to each other.

In another embodiment, the images comprises colours other than shades of grey. The above calculations, relating to the method for detecting striations and the conformity checking method, may notably be performed on each type of colour independently of each other, in order to detect and/or check red, green and blue striations, for example. The calculations may also apply to values based on combinations of these colour values.

In another embodiment, the images form spaces which are not two-dimensional but three-dimensional, comprising voxels. Thus, in addition to the grey levels or other colour levels, each voxel comprises a luminance value. The above calculations may therefore also be performed on levels of depth. Thus, even with identical or similar colours, it is possible to reference, determine and/or check striations that are distinguished from each other by their relief.

The method for detecting areas of striations described in Part II and the method for checking the conformity of the striations described in Part III may be used independently of each other. In particular, the conformity of the striations may be checked according to the method of Part III after an area of striations has been detected in a way that is different from the method of Part II, and vice versa.

1-13. (canceled)

14. A method for referencing types of striations in digital representations of tires, the method comprising steps of:
using a processor to determine at least one representation that includes a type of striation to be referenced;
using the processor to identify at least one segment of pixels or voxels of the at least one representation; and
recording, in a memory coupled to the processor, at least one value relating to differences between grey levels or colour levels of the pixels or voxels of the at least one segment.

15. The method according to claim 14, wherein one or more of the at least one value is or are selected from:
a mean period of periods relating to the pixels or voxels of the at least one segment,
a mean of absolute values of differences between grey levels or colour levels within each pair of adjacent pairs of the pixels or voxels of the at least one segment, and
a length determined based on the mean period.

16. A method for checking a tire to locate an area of striations in a digital representation of the tire, the method comprising steps of:
considering at least one pixel or voxel of an area of a representation; and,
for each of the at least one pixel or voxel considered:
using a processor to identify a segment of pixels or voxels centered on the pixel or voxel under consideration,
using the processor to determine at least one value relating to differences between grey levels or colour levels of pixels or voxels of the segment, and
using the processor to compare the at least one value with at least one predetermined threshold.

17. The method according to claim 16, wherein the at least one value is a mean of absolute values of differences of levels within each pair of adjacent pairs of the pixels or voxels of the segment.

18. The method according to claim 16, wherein the at least one value is a mean period of periods relating to the pixels or voxels of the segment.

19. The method according to claim 16, wherein the at least one value is a number of periods relating to the pixels or voxels of the segment.

20. The method according to claim 16, wherein the at least one value is a length of a period relating to the pixels or voxels of the segment.

21. The method according to claim 16, wherein
the processor associates a binary value of “0” or “1” with each pixel or voxel of the segment based on a level of the pixel or voxel, and
the at least one value relates to differences between levels within each pair of adjacent pairs of pixels or voxels of the segment when the processor scans the segment in one direction, with the differences being identical, and with a first pixel or voxel of each pair of adjacent pixels or voxels including a value identical to that of a pixel or voxel of the segment located at an end of the segment predetermined according to the one direction.

22. The method according to claim 16, wherein
the processor associates a binary value of “0” or “1” with each pixel or voxel of the segment based on a level of the pixel or voxel, and
the at least one value relates to differences between levels within each pair of adjacent pairs of pixels or voxels of the segment when the processor scans the segment in one direction, with the differences being identical, and with a first pixel or voxel of each pair of adjacent pixels or voxels including a value different from that of a pixel or voxel of the segment located at an end of the segment predetermined according to the one direction.

23. The method according to claim 16, further comprising steps of:
the processor determining at least one dilation of a base representation that includes at least one area of striations of the tire, to obtain a dilated representation;
the processor causing at least one erosion of the base representation, to obtain an eroded representation; and
the processor determining a difference between the dilated representation and the eroded representation, to obtain a difference representation.

24. A computer-readable storage medium storing coded instructions that, when executed by a computer, causes the computer to performs a method for checking a tire to locate an area of striations in a digital representation of the tire, wherein the method includes steps of:
evaluating at least one pixel or voxel of an area of a representation; and,
for each of the at least one pixel or voxel evaluated:
identifying a segment of pixels or voxels centered on the pixel or voxel under evaluation,
determining at least one value relating to differences between grey levels or colour levels of pixels or voxels of the segment, and
comparing the at least one value with at least one predetermined threshold.

25. A computerized device for checking a tire to locate an area of striations in a digital representation of the tire, the computerized device comprising a processor and a memory coupled to the processor, wherein the processor is programmed to perform that include:
evaluating at least one pixel or voxel of an area of a representation; and,
for each of the at least one pixel or voxel evaluated:
identifying a segment of pixels or voxels centered on the pixel or voxel under evaluation,
determining at least one value relating to differences between grey levels or colour levels of pixels or voxels of the segment, and
comparing the at least one value with at least one predetermined threshold.

26. The computerized device according to claim 25, wherein the memory is a recording medium storing a database of values relating to striations.
